(19) United States
(12) Patent Application Publication
(10) Pub. No.: US 2008/0034135 A1
(43) Pub. Date: Feb. 7, 2008

(54) PORTABLE DEVICE WITH EMBEDDED IDENTIFICATION MODULES

(75) Inventors: WEN-WU WANG, Shenzhen (CN); SHIH-FANG WONG, Tu-Cheng (TW); TSUNG-JEN CHUANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/833,240

(22) Filed: Aug. 3, 2007

(30) Foreign Application Priority Data
Aug. 4, 2006 (CN) 200610061987.3

(51) Int. Cl. G06F 13/38

(52) U.S. Cl. 710/63

(57) ABSTRACT

A portable device capable of distinguishing peripherals is provided in the present invention. The portable device performing at least one extended function includes: one of peripherals connecting to the portable device; an interface connectable to the peripheral; and a memory storing an index table that lists at least one identification code of the peripheral. Each of the peripheral includes: an interface connectable to the interface of the portable device, a peripheral function module performing a peripheral function after the peripheral connected to the portable device, and an identification module with a device specific identification code.

### BACKGROUND

1. Technical Field

The present invention relates to a portable device and its peripherals, particularly to a portable device with embedded identification modules to distinguish off-board peripherals.

2. Related Art

The two most popular trends of portable devices are miniaturization and functionality. A typical portable device with multiple functionalities is a mobile phone with Bluetooth, media player, camera, etc. In order to integrate these functions in the mobile phone, the mobile phone manufacturer has to reduce the performance of the integrated functions. For example, the resolution and color of a picture captured by the mobile phone is inferior to a picture captured by a professional camera. However, a user of the mobile phone rarely uses the additional functionalities of the mobile phone. Only in limited circumstance, the user uses an image capturing function or a media playing function of the mobile phone. Therefore, it is unnecessary for the mobile phone to integrate all the additional hardware functionality.

Considered from another respect, if the portable device, instead of integrating the additional functionalities, includes interfaces, only, for connecting peripherals that perform the functions, the appearance of the portable device will be improved and the cost of the device will be less.

Accordingly, it would be advantageous if portable devices are small in dimension with a plurality of selectable extended functionalities. The selectable extended functionalities are achieved by connecting different peripherals to the portable device by an interface.

### SUMMARY

A portable device capable of distinguishing peripherals is provided in the present invention. The portable device performing at least one extended function includes: one of peripherals connecting to the portable device; an interface connectable to the peripheral; and a memory storing an index table that lists at least one identification code of the peripheral.

The present invention further provided a portable device performs a basic function capable of identifying at least one peripheral. The portable device includes: an interface connected to the peripheral, and a memory storing an index table that lists at least one identification code of the peripheral.

The present invention further provides many peripherals for extending functionalities for a portable device. Each of the peripheral includes: an interface connected to the interface of the portable device, a peripheral function module performing a peripheral function after the peripheral connected to the portable device, and an identification module with a device specific identification code.

### BRIEF DESCRIPTION OF THE DRAWINGS

FIG. 1 is a block diagram of a hardware infrastructure of an electronic product in accordance with a preferred embodiment of the present invention;

FIG. 2 is a block diagram of a multimedia mobile phone and a Bluetooth transceiver in accordance with the present invention; and

FIG. 3 is a flowchart of a preferred procedure for presenting an operation process according to the present invention.

### DETAILED DESCRIPTION OF THE EMBODIMENTS

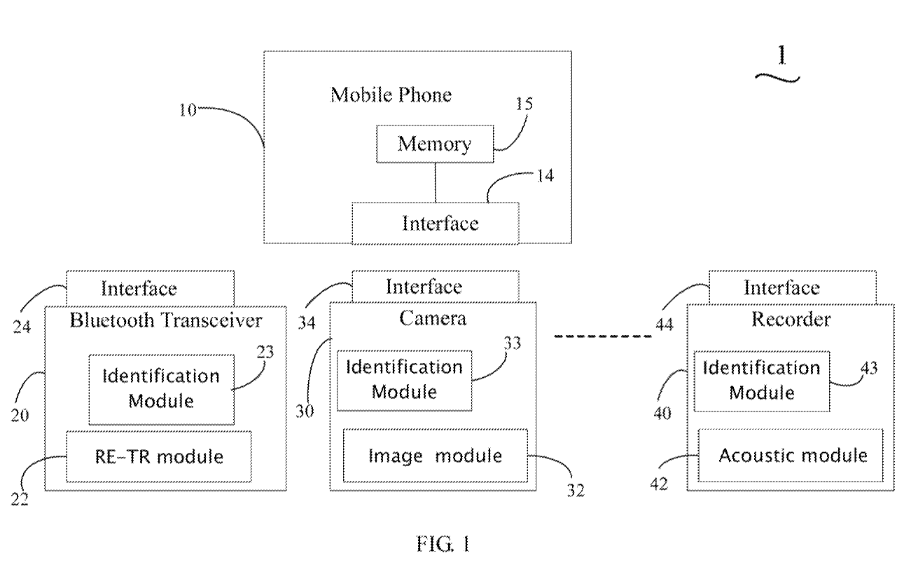

FIG. 1 is a block diagram of a hardware infrastructure of an electronic product 1 in accordance with a preferred embodiment of the present invention. The electronic product 1 consists of at least one portable device such as a mobile phone and one or more peripherals. The peripheral can be either of, but not limited to, a Bluetooth transceiver 20, a camera 30, and a recorder 40.

The mobile phone 10 includes an interface 14 that is connectable to one of the peripherals. The mobile phone 10 further includes a memory 15 that stores an index table that lists at least one identification code of the peripheral. The memory further stores a plurality of driver programs that enables the mobile phone 10 to control and communicate with the peripherals.

Each of the peripherals of the mobile phone 10 includes an interface 24 (34 or 44) that is connectable to the interface 14 of the mobile phone 10, a peripheral function module 22 (32 or 42) that is used to perform a peripheral function after the peripheral is connected to the mobile phone 10, and an identification module 23 (33 or 43) with an identification code that identifies the peripheral. After the peripheral is connected to the mobile phone 10, the mobile phone 10 detects the device category of the peripheral according to the identification code. The mobile phone 10 then selects and loads a corresponding driver program according to the device category thus enabling the mobile phone 10 to control and communicate with the peripheral. For example, when the interface 34 of the camera 30 first connects to the mobile phone 10, the mobile phone 10 detects the camera 30 by accessing the identification module 33 of the camera 30, and then selects and loads a camera driver program. Thus the mobile phone 10 can perform an image capturing function by connecting the camera 30.

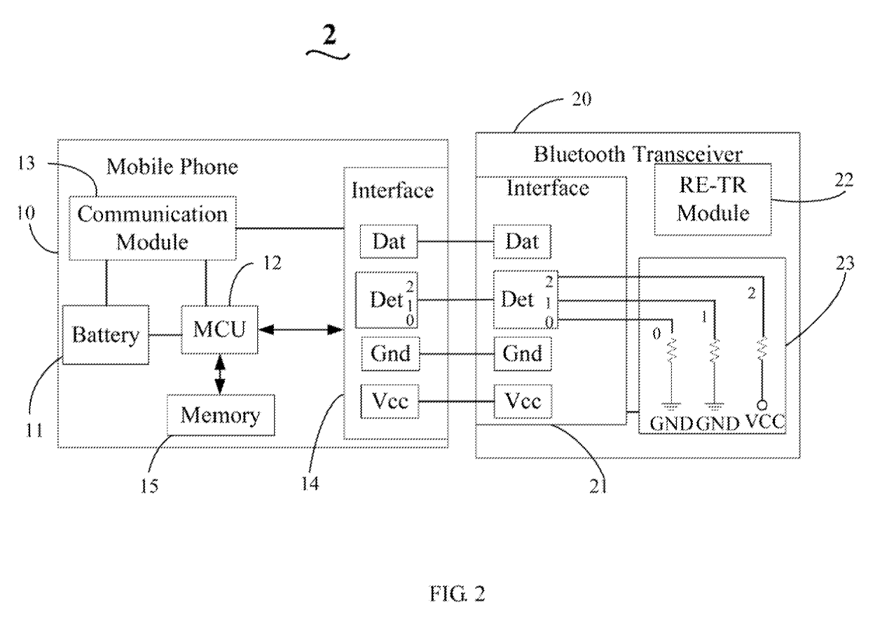

The electronic product is not limited to the mobile phone 10 with peripherals, it also can be a media player or other electronic products with peripherals. FIG. 2 is a block diagram of a multimedia mobile phone 2 in accordance with the present invention. The multimedia mobile phone 2 includes a mobile phone 10 and a plurality of peripherals.

The mobile phone 10 includes a micro-control unit (MCU) 12 connected with a battery 11, a communication module 13, an interface 14, and the memory 15. The mobile phone 10 can perform a basic speech communication function by driving the communication module 13. The multimedia mobile phone 2 can also perform other functions by connecting other different peripherals to the mobile phone 10. The interface 14 of the mobile phone 2 is connected to an interface of one of peripherals. For exemplary purposes, a Bluetooth transceiver 20 is connected to the mobile phone 10 to illustrate how the mobile phone 10 detects and drives the Bluetooth transceiver 20.

The interface 14 of the mobile phone 10 consists of a power (VCC) pin, a ground (GND) pin, at least one detection (DET) pin, and at least one data (DAT) pin. The number of the DET pin(s) of the interface 14 determines the number of the peripherals of the mobile phone 10. If the number of the DET pin(s) is “N” (N being a natural number), the number of the peripherals of the mobile phone 10 is less than or equal to 2^{N}. In the preferred embodiment, the interface 14 of the mobile phone 10 has three DET pins, so the number of the peripherals of the multimedia mobile phone 2 is less or equal to 8 (2³=8). The DET pins are defined as a DET “2”, a DET “1”, and a DET “0” respectively, and one end of each of the DET pins is connected to the MCU 12. The identification code of each of peripherals is determined by a numerical value loaded on the DET “2”, the DET “1”, and the DET “0”.

The memory 15 stores an index table that lists device categories corresponding to identification codes of different peripherals. The following table is an example of the list, where the identify codes “10” and “11” are not allotted to any peripheral.

| | Identification code | | |
|---|---|---|---|
| Peripheral Category | DET “0” | DET “1” | DET “2” |
| Battery Charger | 0 | 0 | 0 |
| Expansion card | 0 | 0 | 1 |
| Camera | 0 | 1 | 0 |
| Video | 0 | 1 | 1 |
| Bluetooth transceiver | 1 | 0 | 0 |
| Media player | 1 | 0 | 1 |
| Vacant | 1 | 1 | 0 |
| Vacant | 1 | 1 | 1 |

The memory 15 further stores a plurality of driver programs that enables the mobile phone 10 to control and communicate with the peripherals.

The Bluetooth transceiver is one of eight peripherals of the multimedia mobile phone 2. As shown in the above index table, each category of the peripherals of the multimedia mobile phone 2 has an identification code that enables the multimedia mobile phone 2 distinguishes the category of one peripheral from other peripherals. The Bluetooth transceiver 20 includes an interface 21, the receiver and transmitter (RE-TR) module 22, and the identification module 23. The RE-TR module 22 is used to receive and transmit data by Bluetooth means.

The identification module 23 provides the identification code of the Bluetooth transceiver 20 by a hardware means. The identification module 23 comprises “N” lines to present the identification code of the Bluetooth transceiver 20. The number of “N” is equal to the number of the DET pins of the interface 14 of the mobile phone 10. In the preferred embodiment, the identification module 23 comprises three lines, that is, a highest line “2”, a middle line “1”, and a lowest line “0”. If the line loaded a high voltage level is defined as a binary bit “1”, and the line loaded a low voltage level is defined as a binary bit ‘0’, the identification module 23 can present 8 different identification codes. Aspects of the Bluetooth transceiver 20, the line “2” is connected to a VCC line having a high voltage level, and line “1” and line “0” are connected to a GND line having a low voltage level. Therefore, the identification code of the Bluetooth transceiver 20 is defined as “100”.

The interface 21 of the Bluetooth transceiver 20 is corresponding to the interface 14 of the mobile phone 10 including a power (VCC) pin, a ground (GND) pin, three detection (DET) pins, and at least one data (DAT) pin. The DET pins are defined as a DET “2”, a DET “1”, and a DET “0” respectively. The DET “2” is connected to the line “2” of the identification module 23, the DET “1” is connected to the line “1” of the identification module 23, and the DET “0” is connected to the line “0” of the identification module 23.

When the multimedia mobile phone 2 is powered on, the DET pins of the interface 14 are set to high voltage level. The voltage level on DET “2”, DET “1”, and DET “0” of the interface 14 will change according to the peripheral connected to the mobile phone 10. For the voltage level on DET “2”, DET “1”, and DET “0” of the interface 21 of the Bluetooth transceiver 20 is “high”, “low” and “low”, the voltage level on the DET “2” retains on high while the voltage levels on the DET “1” and the DET “0” are pulled down to low when the Bluetooth transceiver 20 is connected to the mobile phone 10. By checking the voltage levels on the DET “2”, DET “1”, DET “0” of the interface 14, the mobile phone 20 detects what the device categories is connected to the mobile phone 10. In the preferred embodiment, the mobile phone 10 detects it is the Bluetooth transceiver 20 connected to the mobile phone 10 by checking the “high”, “low” and “low” voltage level on the DET “2”, DET “1”, DET “0” of the interface 14. Therefore, the mobile phone 20 selects a Bluetooth driver program to control and communicate with the Bluetooth transceiver 20. The multimedia mobile phone 2 extends the Bluetooth function by connecting the Bluetooth transceiver 20 into the mobile phone 10.

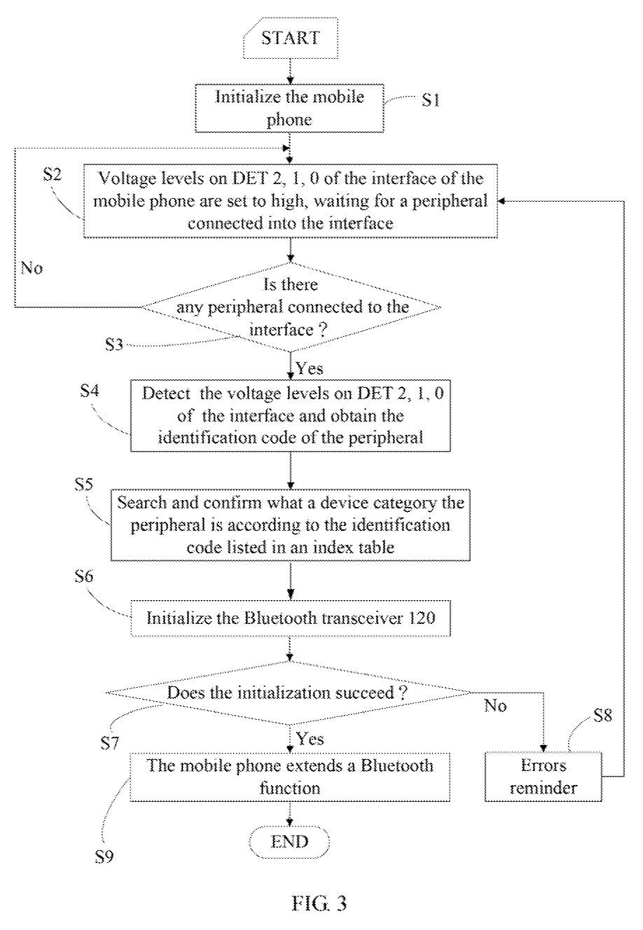

FIG. 3 is a flowchart illustrating a preferred procedure presenting an operation process how the mobile phone distinguishes and driving different peripherals.

In step S1, the mobile phone 10 is initialized. The mobile phone 10 can perform a basic function, such as speech communication.

In step S2, the voltage levels on DET “2”, DET “1”, DET “0” of the interface 14 of the mobile phone 10 are set to high.

In step S3, the MCU 12 detects whether any peripheral (e.g., the Bluetooth transceiver 20) is connected to the interface 14. If the Bluetooth transceiver 20 is connected to the interface 14, the procedure goes to step S4. If the Bluetooth transceiver 20 is not connected to the interface 14, the procedure goes back to step S2.

In step S4, the Bluetooth transceiver 20 is connected to the mobile phone 10, the MCU 12 accesses the identification code “100” of the Bluetooth transceiver 10 according to the “high”, “low”, “low” voltage levels on the DET “2”, “1”, “0”.

In step S5, the MCU 12 searches and confirms that a device category corresponding to the identification code “100” is a Bluetooth transceiver 20 according to the index table.

In step S6, the MCU 12 selects and loads a driver program for the Bluetooth transceiver 20 according to the confirmed device category to initialize the Bluetooth transceiver 20.

In step S7, the MCU 12 judges whether the initialization is successful. If the initialization fails, the procedure goes to step S8, otherwise the procedure goes to step S9.

In step S8, the initialization fails, the MCU 12 feedbacks an error warning to the multimedia mobile phone 2 by an image warning or by a buzzer warning to remind the user to connect the Bluetooth transceiver 20 again. After a new connection, the procedure goes back to step S2.

In step S9, the initialization succeeds, the multimedia mobile phone 2 extends a Bluetooth function by driving, communicating and controlling the Bluetooth transceiver 20.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A portable device performing at least one extended function, the portable device comprising:
at least one peripheral connectable to the portable device;
an interface connectable to the at least one peripheral; and
a memory storing an index table that lists at least an identification code of the at least one peripheral;
the portable device is capable of identifying the at least one peripheral; and the portable device performs a basic function without the at least one peripheral and performs an extended function by connecting to the at least one peripheral.

2. The portable device according to claim 11, wherein the at least one peripheral performs a peripheral specified function of the electronic product, the at least one peripheral comprising:
an interface connectable to the interface of the portable device;
a peripheral function module performing a peripheral function after the peripheral connectable to the portable device; and
an identification module providing an identification code for the at least one peripheral.

3. The electronic product according to claim 2, wherein the identification module provides the identification code of the peripheral by a hardware means.

4. The electronic product according to claim 3, wherein the identification module comprises “N” (N being a natural number) lines to identify the peripheral.

5. The electronic product according to claim 4, wherein the interface of the peripheral comprises a power (VCC) pin, a ground (GND) pin, at least one detection (DET) pin, and at least one data (DAT) pin, wherein the DET pin is connected to the identification module.

6. The electronic product according to claim 5, wherein the interface of the portable device comprises a power (VCC) pin, a ground (GND) pin, at least one detection (DET) pin, and at least one data (DAT) pin, wherein the DET pin is connected to a micro-control unit (MCU).

7. The electronic product according to claim 6, wherein the interface of the at least one peripheral is corresponding to the interface of the portable device.

8. The electronic product according to claim 7, wherein the portable device detects what a device category of the peripheral connected to the portable device is by checking a voltage level on the at least one DET pin.

9. The electronic product according to claim 8, wherein the memory further stores at least one driver program that enables the portable device to control and communicate with the at least one peripheral.

10. The electronic product according to claim 9, wherein the portable device access the at least one driver program for the at least one corresponding peripheral according to the identification code and the device category listed in the index table stored in the memory.

11. A portable device performing a basic function capable of identifying at least one peripheral, comprising:
an interface connectable to the at least one peripheral; and
a memory storing an index table that lists at least one identification code of the at least one peripheral.

12. The portable device according to claim 11, wherein the interface of the portable device comprises a power (VCC) pin, a ground (GND) pin, at least one detection (DET) pin, and at least one data (DAT) pin, wherein the DET pin is connected to a micro-control unit (MCU).

13. The portable device according to claim 12, wherein the memory further stores at least one driver program that enables the portable device to control and communicate with the at least one peripheral.

14. The portable device according to claim 13, wherein the portable device access the at least one driver program for the at least one corresponding peripheral according to the identification code and the device category listed in the index table stored in the memory.

15. A peripheral performing a peripheral specified function when connected to a portable device, comprising:
an interface connectable to the interface of the portable device;
a peripheral function module performing a peripheral function after the peripheral connectable to the portable device; and
an identification module with a device specific identification code.

16. The peripheral according to claim 15, wherein the identification module provides the identification code by a hardware means.

17. The peripheral according to claim 16, wherein the identification module comprises “N” (N being a natural number) lines to identify the peripheral.

18. The peripheral according to claim 17, wherein the interface of the peripheral comprises a power (VCC) pin, a ground (GND) pin, at least one detection (DET) pin, and at least one data (DAT) pin, wherein the DET pin is connected to the identification module.
